(19) United States
(12) Patent Application Publication
(10) Pub. No.: US 2025/0284156 A1
(43) Pub. Date: Sep. 11, 2025

(54) METHOD(S) AND/OR APPARATUS(ES) TO HANDLE VISUAL HACKING

(71) Applicants: Terry James Scheffer, Hilo, HI (US); Sidney Lynn True, West Linn, OR (US)

(72) Inventors: Terry James Scheffer, Hilo, HI (US); Sidney Lynn True, West Linn, OR (US)

(21) Appl. No.: 18/601,251

(22) Filed: Mar. 11, 2024

(51) Int. Cl. G02F 1/1335; G02F 1/1337; G02F 1/139

(52) U.S. Cl. CPC G02F 1/133509; G02F 1/133533; G02F 1/1337; G02F 1/1396; H04N 13/332; H04N 2013/40

(57) ABSTRACT

Briefly, embodiments, such as methods and/or systems to handle visual hacking, for example, are described.

### BACKGROUND

### 1. Field

This disclosure relates to one or more methods and/or one or more apparatuses to handle visual hacking.

### 2. Information

“Visual Hacking” is a term coined by the 3M Company. See https://www.youtube.com/watch?v=4HuocKZySPk. It may arise in various situations, such as with devices that typically include an optical display, such as a laptop computer, a smart cell phone, an electronic tablet; however, other optical displays are also contemplated, such as a desktop monitor, a display on an airplane, etc. One example, without loss of generality, typically involves a situation in which unauthorized persons peer over the shoulders of users to read content, often private, present on an optical display, such as may be connected or coupled to a computing device, such as a laptop computer, again as an example. This practice is becoming more widespread as users employ various types of computing devices with an optical display in public places, such as cafes, hotel lobbies, airline lounges and/or airplanes, as examples. A 2017 infographic, https://multimedia.3m.com/mws/media/1370385O/public-spaces-infographic.pdf, and full report, https://multimedia.3m.com/mws/media/1370386O/public-spaces-survey-research-report.pdf, found that 87% of mobile workers interviewed said they have caught someone in a public space looking over their shoulder at their laptop screen. The incidence of visual hacking has only gotten worse and is likely to continue with the recent trend to remote and hybrid workspaces with employees spending more time working in public spaces.

Unfortunately, suggested approaches to handle visual hacking are either inadequate or overly complex. For example, 3M sells a laptop privacy screen to place in front of an optical display; however, it only handles visual hacking from oblique side angles. It does not address head on visual hacking. Other approaches, while addressing visual hacking from less oblique side angles, for example, may involve significant modifications to hardware platform electronics of an optical display to permit some type of user control over viewing angle, such as backlighting schemes to enable a user to widen or narrow viewing angle, as an example. Thus, an approach to address these shortcomings is desirable.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1A is a schematic diagram illustrating an example embodiment of claimed subject matter with left and right liquid crystal shutter lenses in a light transmitting state using a pi-cell with 0 v applied;

FIG. 1B is a schematic diagram illustrating an example embodiment of claimed subject matter with left and right liquid crystal shutter lenses in a light blocking state using a pi- cell with 15 v applied;

FIG. 2A is a schematic diagram illustrating an example embodiment of claimed subject matter of a system including eyewear with liquid crystal shutter lenses switched to a substantially transparent state to allow a viewer using such eyewear to see intended or desired image content on an optical display;

FIG. 2B is a schematic diagram illustrating an example embodiment of claimed subject matter of a system including eyewear with liquid crystal shutter lenses switched to an opaque or light blocking state so a viewer using such eyewear does not see obscuring image content on an optical display;

FIG. 2C is a schematic diagram illustrating the example embodiment of FIGS. 2A and 2B in which a viewer without eyewear sees a superposition of intended or desired image content and obscuring image content;

FIG. 3 is a schematic diagram of an embodiment of a computing and/or communications network capable of use with an embodiment in accordance with claimed subject matter, such as a computing device or similar platform that may be connected or coupled to an optical display;

FIG. 4 is a schematic diagram illustrating an example embodiment in accordance with claimed subject using temporal interleaving of light to handle visual hacking;

FIG. 5 is a graph showing an example of the relationship between the gray levels of a desired image and the gray levels of an obscuring image in one approach to handle visual hacking;

FIG. 6 is a schematic diagram illustrating an example of an approach to handle visual hacking in accordance with claimed subject matter;

FIG. 7 is a schematic diagram illustrating an example of another approach to handle visual hacking in accordance with claimed subject matter;

FIG. 8 is a schematic diagram illustrating an example embodiment in accordance with claimed subject matter using an LCD and a microretarder and spatial interleaving of light to handle visual hacking;

FIG. 9 is a schematic diagram illustrating an example embodiment in accordance with claimed subject matter using an OLED (or micro LED) display and a microretarder and spatial interleaving of light to handle visual hacking;

FIG. 10 is a schematic diagram illustrating an example embodiment in accordance with claimed subject matter using an LCD and a micropolarizer and spatial interleaving of light to handle visual hacking;

FIG. 11 is a schematic diagram illustrating an example embodiment in accordance with claimed subject matter using an OLED or micro-LED display and a micropolarizer and spatial interleaving of light to handle visual hacking.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Furthermore, structural and/or other changes may be made without departing from claimed subject matter. It should also be noted that directions and/or references, for example, such as up, down, top, bottom, front, rear, and so on, may be used to facilitate discussion of drawings and are not intended to restrict application of claimed subject matter. For example, the term “top” or “front” may be used to refer to the part of an optical display for a computing device that faces a user. Therefore, the following detailed description is not to be taken to limit claimed subject matter and/or equivalents. Further, it is to be understood that other embodiments may be utilized. Also, several embodiments have been provided of claimed subject matter and it is noted that, as such, those illustrative embodiments are inventive and/or unconventional; however, claimed subject matter is not limited to embodiments provided primarily for illustrative purposes. Thus, while advantages have been described in connection with illustrative embodiments, claimed subject matter is inventive and/or unconventional for additional reasons not expressly mentioned in connection with those embodiments. In addition, references throughout this specification to “claimed subject matter” refer to subject matter intended to be covered by one or more claims and are not necessarily intended to refer to a complete claim set, to a particular combination of claim sets (e.g., method claims, apparatus claims, etc.), or to a particular claim.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application. Furthermore, the term “substantially” used with respect to a particular property means any measurable difference or tolerance with respect to meeting the particular property is within a level acceptable to one of ordinary skill in the relevant art.

“Visual Hacking” is a term coined by the 3M Company. See https://www.youtube.com/watch?v=4HuocKZySPk. It may arise in various situations, such as with devices that typically include an optical display, such as a laptop computer, a smart cell phone, an electronic tablet; however, other optical displays are also contemplated, such as a desktop monitor, a display on an airplane, etc. One example, without loss of generality, typically involves a situation in which unauthorized persons peer over the shoulders of users to read content, often private, present on an optical display, such as may be connected or coupled to a computing device, such as a laptop computer, again as an example. This practice is becoming more widespread as users employ various types of computing devices with an optical display in public places, such as cafes, hotel lobbies, airline lounges and/or airplanes, as examples. A 2017 infographic, https://multimedia.3m.com/mws/media/13703850/public-spaces-infographic.pdf, and full report, https://multimedia.3m.com/mws/media/13703860/public-spaces-survey-research-report.pdf, found that 87% of mobile workers interviewed said they have caught someone in a public space looking over their shoulder at their laptop screen. The incidence of visual hacking has only gotten worse and is likely to continue with the recent trend to remote and hybrid workspaces with employees spending more time working in public spaces.

Unfortunately, suggested approaches to handle visual hacking are either inadequate or overly complex. For example, 3M sells a laptop privacy screen to place in front of an optical display; however, it only handles visual hacking from oblique side angles. It does not address head on visual hacking. Other approaches, while addressing visual hacking from less oblique side angles, for example, may involve significant modifications to hardware platform electronics of an optical display to permit some type of user control over viewing angle, such as backlighting schemes to enable a user to widen or narrow viewing angle, as an example.

Thus, an approach to address these shortcomings is desirable.

At a high level, an approach in accordance with claimed subject matter may comprise (1) obscuring content that is to be protected from visual hacking so that a visual hacker is unable to comprehend content to be protected from simply viewing an optical display that displays such content, regardless of viewing angle, location of the hacker relative to the optical display, etc., and (2) providing a user viewing an optical display an ability to view protected content without anyone else, particularly a visual hacker, also having the ability to do so. Thus, in an illustrative embodiment both aspects may be desirable.

For example, in an illustrative embodiment, a method to handle visual hacking of an optical display may comprise combining light providing obscuring image content via an optical display and light providing intended image content via an optical display so that light may be combined in a temporal manner and/or in a spatial manner to obscure image content intended to be protected (“intended image content”). Likewise, viewing combined light through a visual screen, for example, is intended to substantially compensate for the manner in which light is combined so as to substantially reveal intended image content and substantially block obscuring image content. Thus, in this illustrative embodiment, content to be protected, referred here interchangeably as desired image content or as intended image content, without loss of generality, may be combined with obscuring image content, referred here interchangeably as dummy image content or as obscuring image content, without loss of generality, so that someone viewing an optical display, such as may be coupled or connected to a computing device, such as a computer, a tablet, a smart cell phone, etc., in an unaided manner may be unable to visually comprehend desired or intended image content, which may comprise images, text, video, etc. In one illustrative embodiment as previously suggested, a visual screen, as an example, may be provided to a user to substantially compensate for the manner in which light for the respective types of content have been combined so that intended image content is able to be viewed by a user while obscuring image content is substantially blocked.

As an illustrative example, light for intended image content and light for obscuring image content may be combined through interleaving light for the intended image content and light for the obscuring image content in a temporal manner and/or in a spatial manner. Likewise, one example of a visual screen may comprise eyewear, such as glasses, for example, although claimed subject matter is not limited in scope in this respect. Alternatively, other types of visual screens may, of course, be employed, such as a visor, as an example. Thus, light emitted from an optical display may be filtered by eyewear, in this illustrative example, based at least in part on at least one of the following light filtering approaches: state of light polarization, temporal or spatial light transmission, and/or temporal or spatial light absorption, as described in more detail below. Specific examples of light polarization state may comprise linear polarization, circular polarization and/or elliptical polarization.

Transmissive optical displays, typically used in conjunction with a computing device, such as those that employ liquid crystal displays (LCDs), may employ two linear polarizing films, generally with their polarization axes substantially crossed, one between a backlight and a liquid crystal cell (LC cell) and another located at an output face of a LC cell facing a observer. In this embodiment, for example, a LC cell may comprise a structure including two transparent substrate plates, such as glass and/or plastic, between which is confined a substantially uniform layer of liquid crystalline material with a perimeter seal, cell spacers to maintain a substantially uniform thickness, liquid crystal alignment layers and drive electrodes. LC cells designed to display content typically also include an array of pixels in which respective pixels may typically be associated with a nonlinear device, such as a transistor, and/or optional color filters for a color display. A liquid crystal display, or LCD, typically includes a LC cell, a light source, such as a backlight, and polarizer sheets and retarder sheets, referred to herein generally as polarizers and retarders, respectively. A polarizer and/or a retarder may be laminated onto the outside of a LC cell, but may also be placed inside a LC cell. It is noted that the terns LCD and LCD display may interchangeably refer to a liquid crystal display without loss of generality. Emissive displays, such as organic light emitting diode (OLED) displays and micro-light emitting diode (micro-LED) displays, use neither a backlight nor a rear polarizer, since they generate their own light, and a front polarizer is also not typically employed. However, some OLED displays, such as may be used in laptop computers, desktop monitors and/or TVs, laminate a circular polarizer onto the front of an OLED display to block ambient light that might otherwise reflect from OLED electrodes of an OLED display and thereby reduce a contrast ratio for such a display. It is noted that the terms OLED and OLED display may be used interchangeably herein to refer to an OLED display without loss of generality. It is also noted that the terms micro-LED and micro-LED display may also be used interchangeably herein to refer to a micro-LED display without loss of generality. In general, LCDs and OLEDs are discussed throughout this patent application as illustrative embodiments; hence, this description is intended to apply to other examples of transmissive and/or light emitting optical displays, without loss of generality.

An LCD, for example, may be operated as an optical display in a variety of electro-optical modes. Such modes for an LCD may include a vertically aligned nematic (VAN) mode, an in-plane switching (IPS) mode, a fringe field switching (FFS) mode, a twisted nematic (TN) mode, a supertwisted nematic (STN) mode, and an optically compensated bend (OCB) mode, as examples. For these modes, two linear polarizers may be employed, one which may be located between a backlight and an LC cell and another at the output face of a LC cell, as described above. In the case for an OLED or micro-LED display, an output polarizer may be added if desired assuming one is not employed to suppress ambient light reflection. Removing a polarizer from the output face of an LCD results in a bright, featureless screen or display even if an image would have been visible if a front polarizer were present. In this example, orientation of the liquid crystal molecules in an optical display may respond to an applied electric field, but since liquid crystal material used in connection with the aforementioned electro-optical modes do not absorb visible light, bright and dark pixels do not form. Hence, relocating the front polarizer of an LCD to the eyewear in substantially the same orientation as would be used for a front polarizer of an optical display would allow a viewer to see an image that resides on the plane of the LCD screen, in this example.

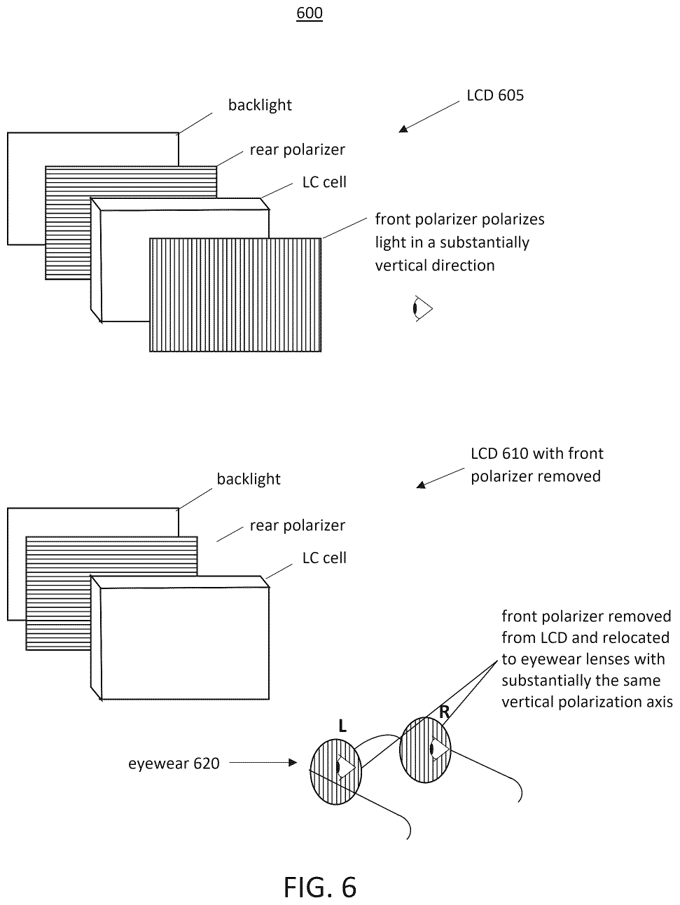

An illustration is provided in FIG. 6 which shows an embodiment 600 including LCD 610 with a polarizer relocated to eyewear 620. FIG. 6 also illustrates a typical optical LCD 605. Except for the TN mode, where polarization direction of a front polarizer is oriented at substantially 45° to a substantially horizontal direction to preserve left/right viewing symmetry, polarization direction of light exiting a front polarizer of most LCD modes is substantially vertically oriented which is also the orientation found in polarized sunglasses designed to filter out substantially horizontally polarized light rays associated with glare while letting through substantially vertically polarized light rays. It is noted that the terms top, front and outer are used interchangeably in this context, without loss of generality. In other words, except tor LCDs using the TN mode, manufacturers typically design LCDs so that light leaving the LCD is substantially vertically polarized. Hence, polarized sunglass wearers are able to read the optical display; otherwise light leaving an LCD might be substantially blocked for a viewer wearing polarized sunglasses. In other words, ordinary polarized sunglasses may be employed as filtering eyewear to view an image on an optical display, such as an LCD, that had its top or outer polarizer removed. However, an approach such as this would not provide secure privacy because people in the area might also wear polarized sunglasses.

An ability of a hacker to see optical display content by wearing polarized sunglasses might be overcome by substituting a front polarizer, such as for an LCD, again, such as 605, as an illustrative example, with a substantially quarter-wave retarder film (substantially QWP retarder) with its slow axis oriented at substantially 45° to a polarization direction of a removed front polarizer (substantially vertical for most LCD modes) and then adding another substantially quarter-wave retarder film oriented at substantially −45° as a component in eyewear for use with such an optical display in which lenses of the eyewear may be laminated to have linear polarizers in a substantially vertical polarization direction.

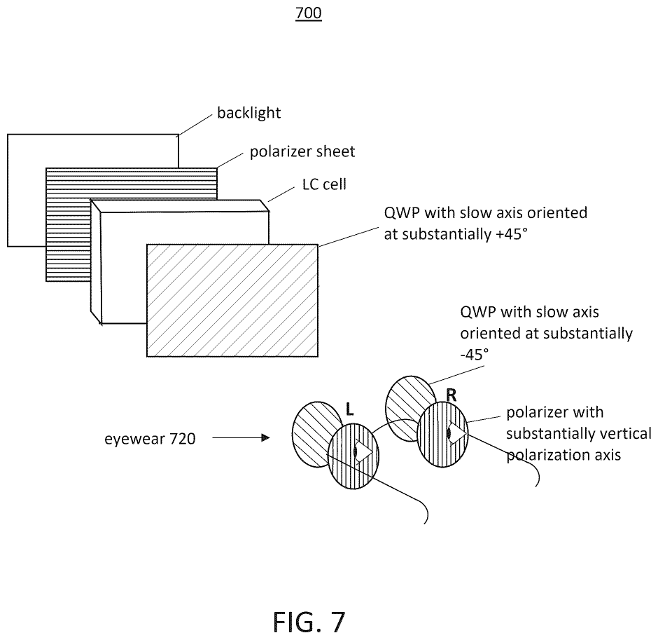

An illustration is provided in FIG. 7 which shows an embodiment 700 of an LCD with a substantially QWP retarder and an eyewear embodiment 720 with another substantially QWP retarder, as described. With this modification, a substantially QWP retarder laminated onto an LC cell, such as for LCD embodiment 700, has its slow axis at substantially right angles to a slow axis of a substantially QWP retarder in eyewear embodiment 720. In this configuration, the two substantially QWP retarders substantially compensate for each other, resulting in substantially zero retardation, resulting in a system able to behave like the one illustrated and discussed with respect to FIG. 6. But a difference with FIG. 6 is that a visual hacker wearing polarized sunglasses will not be able to see an intended image, but, instead, will see a scrambled image since light and dark pixels that would have appeared on the optical display before removal of an outer or front polarizer would now appear to have the same intensity, but not to someone wearing eyewear 720. Filtering eyewear for this illustrative embodiment may be similar to throwaway plastic glasses, such as those provided by movie theaters in connection with 3-D movies, except that in this embodiment, respective lenses of the filtering eyewear would have substantially the same QWP retarder orientation rather than being rotated by substantially 90° from one another. Of course, a drawback of this scheme is that it involves removal of the front polarizer film on or over the outside of an optical display facing the user and replacing it with a substantially QWP retarder, consequently, making it effectively useless if someone wanted to operate, for example, a laptop optical display in the usual way without eyewear 720.

Since most optical displays that employ LCDs, and many OLEDs, and/or micro-LEDs, use front polarizing filters on or over the top of an outside face of an optical display, for most of these sorts of optical displays, a polarizing filter is typically a final polarization-affecting component facing a viewer. For most such optical displays, orientation of a transmission axis of a polarizing filter on or over the outside front of an optical display is oriented to pass light polarized in a substantially vertical direction so that a viewer wearing polarized sunglasses, which blocks substantially horizontally polarized light, but passes substantially vertically polarized light, is able to view displayed content.

Polarization direction and/or state of light emitted from an optical display may matter, for example, for eyewear to be designed to improve light throughput to a viewer. The following description of embodiments in accordance with claimed subject matter assumes a polarizing filter on or over the outside front of an optical display that passes light polarized in a substantially vertical direction, as is typically the case. However, eyewear could be modified to accommodate other polarization directions and/or states if desired or appropriate.

In accordance with claimed subject matter, several embodiments are discussed in which modifications to hardware platform electronics or structure of a typical optical display, as just discussed, may be omitted. Rather, for a typical optical display coupled or connected to a computing device, such as a laptop computer, smart cell phone, or an electronic tablet, embodiments such as described below may be accomplished with software modifications without otherwise changing basic electronic and/physical structure inside an optical display. Thus, a computing device, such as a laptop, for example, may be operated as usual, showing intended images that everyone who looks at an optical display are able to see, and then with a single keystroke, as an example, an optical display may be switched to a private mode where only an authorized viewer with a filtering visual screen or with appropriately filtering eyewear, as described in more detail below, would be able to see intended image content as a result of an optical display emitting light that combines light providing intended image content with light providing obscuring image content, for an illustrative embodiment.

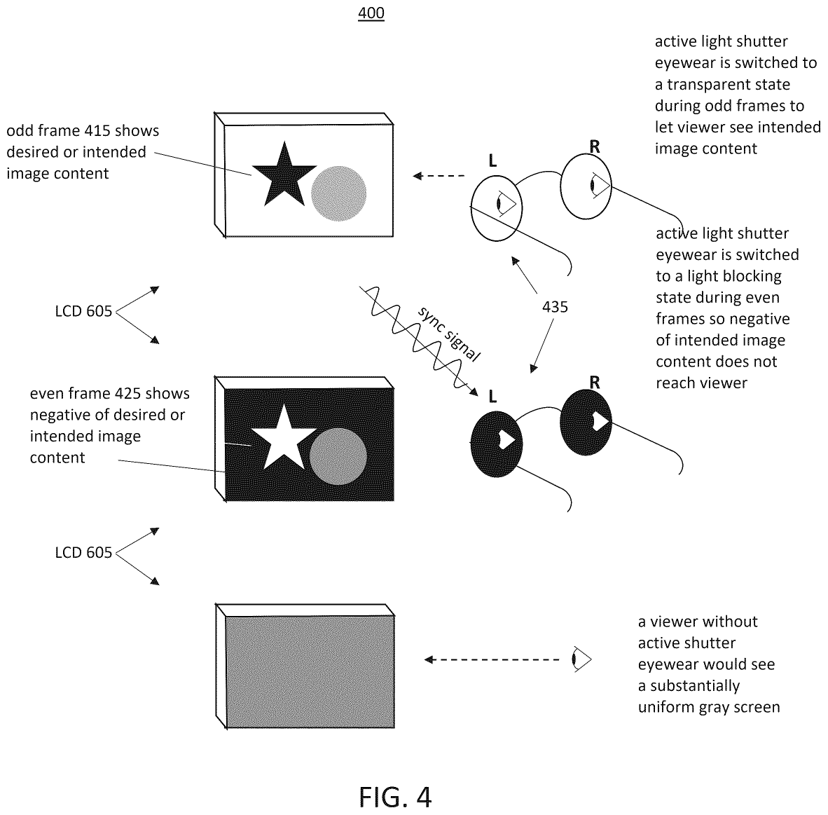

In general, embodiments in accordance with claimed subject matter may combine light, as suggested previously, by interleaving in a temporal and/or a spatial manner light providing intended image content and light providing obscuring image content. FIG. 4 shows an illustrative embodiment 400, including LCD 605, employing temporal interleaving, although, of course, claimed subject matter is not intended to be limited to embodiments provided as illustrative.

In FIG. 4, odd frame 415, which may appear on an LCD, such as 605, for example, shows desired or intended image content on so-called odd frames. Likewise, so-called even frames 425, which may also appear on an LCD, such as 605, for example, shows dummy or obscuring image content. The terms odd frames and even frames, here, refers to temporally interleaving light emitted from the optical display, as explained in more detail. Thus, in this illustrative embodiment, an optical display alternates between emitting light providing intended image content and light providing obscuring image content. With a sufficiently short frame rate, the rate at which light emitted from the optical display is alternated between intended image content and obscuring image content in this embodiment, a viewer without any special eyewear, for example, will see as a superposition of intended image content and obscuring image content. For example, temporally alternating at about 1/60^{th} of a second or faster is expected to produce a superposition of respective image content for a viewer. Furthermore, frame rates or periods (used here interchangeably) with time intervals of 1/120^{th} of a second or shorter are common in today's LCDs, so no flicker should be observed in rapidly switching between light providing intended image content and light providing obscuring image content. It is noted that to further protect intended content, an interleaving time interval may vary so that only eyewear appropriately synchronized to the manner in which light is temporally alternated, as described below, would provide a user the ability to suitably view intended image content. Likewise, a time interval may furthermore be adjusted asynchronously to provide similar or perhaps better protection of content. To a user without appropriate eyewear, image content shown on an optical display, such as an LCD, as discussed, would appear as a confusing superposition of intended image content and obscuring image content, or as a featureless, neutral gray screen if obscuring image content, in an embodiment, for example, were a negative of intended image content. This is due at least in part to persistence of vision of an unaided human eye in which interleaved light that is rapidly switched in a temporal manner appears to an unaided human eye as a superposition of content provided by interleaved light.

Eyewear for this illustrative embodiment, such as illustrated in FIG. 4 by eyewear embodiment 435, may use active light shutter eyewear whose lenses are essentially open (e.g., substantially transparent) during odd frames and essentially closed (e.g., substantially opaque) during even frames to, in effect, filter interleaved light emitted from an optical display. In this content, the term light shutter and/or light valve refers to a device that employs liquid crystal material to affect light intensity that passes through the light shutter or light valve; however, the term light shutter specifically refers specifically a device that substantially passes light or that substantially blocks light, as in a window shutter by analogy. An active light shutter refers to a light shutter that changes state, such as substantially passing or substantially blocking, due at least in part to active operation thereof. Active operation, which may also apply to a light valve, may include active electrical actuation, for example, which may, for example, include a change in voltage, a change in current and/or both such that a state of a light shutter is changed.

Active shutter eyewear embodiment 435 differs from other types of active light shutter eyewear that may be used, for example, with respect to some 3-D televisions. That is, for this illustrative embodiment, right- and left-eye lenses open and close in tandem rather than alternately opening and closing as may be done in connection with active light shutter eyewear used to generate 3-D images, for example. In the manner described, for illustrative embodiment 400, since optical display 605 is temporally alternating between emitting light that provides intended image content and emitting light that provides obscuring image content, eyewear 435 operates to substantially reveal intended image content and to substantially block obscuring image content for a user wearing eyewear embodiment 435, for example.

Furthermore, for illustrative embodiment 400, opening and closing of lenses of active light shutter eyewear embodiment 435 may be, in effect, synchronized with sequential frame periods of an optical display, here, as an example, an LCD, again, such as 605. For example, a computing device coupled or connected to an optical display able to interleave light, as suggested, may comprise a laptop, as one example, could send a synchronizing signal received by eyewear electronics for eyewear embodiment 435, such as in the form of a Bluetooth signal or in the form of an infrared light pulse, as examples, to synchronize opening and closing of lenses of active light shutter eyewear embodiment 435. However, for some embodiments, such a synchronizing signal, may perhaps even be omitted. For example, in an embodiment, a photodetector may be mounted on an eyewear embodiment to detect synchronization for situations in which, for example, overall light intensity of intended image content and overall light intensity of obscuring image content may be sufficiently different for such detection.

Numerous fast, active light shutter implementations using liquid crystals are known to accomplish such operation, such as operation described with respect to illustrative embodiment 435. For example, Phillip J. Bos in U.S. Pat. No. 5,187,603 describes fast liquid crystal light shutter glasses with lenses using a single LC cell operating as a pi-cell. Even faster light shutters may be made using two liquid crystal layers as described, for example, by Cheng et al., in the Journal of the SID, 22/5 pp.229-236 (2015) entitled “Low voltage fast response display using dual pi-cells with quarter-wave thickness” and Osterman and Scheffer in U.S. Pat. No. 8,023,052. For example, a liquid crystal layer used in these active shutter embodiments may either rotate the direction of linear polarized light from the input surface to the output surface by substantially 90° or otherwise not perform such a rotation, depending on an applied voltage, for example. Placing a liquid crystal layer between substantially orthogonally oriented polarizer layers results in an active light shutter that is able to switch from a substantially light blocking or substantially opaque (used interchangeably, herein) state to a substantially light transmitting state. For good transmittance, an outer polarizer, such as for active light shutter eyewear embodiment 435, facing an LCD should be substantially vertically polarized to be compatible with typical electro-optical modes for an LCD, such as a vertically aligned nematic (VAN) mode, an in-plane switching (IPS) mode, a fringe field switching (FFS) mode, and/or an optically compensated bend (OCB) mode, as previously described. For the TN mode, however, an outer polarizer, such as for active light shutter eyewear embodiment 435, facing an LCD should be polarized at substantially 45° to make its polarization direction substantially the same as the polarization direction of the outer polarizer for an LCD operating in TN mode.

If obscuring image content in an embodiment, such as 425, for example, is chosen to be a negative of intended image content in an embodiment, such as 415, a simple look-up-table may, for example, be used in an embodiment to generate a negative image so that an average of a positive image (e.g., intended image content) content and a negative image (e.g. obscuring image content) content may produce a substantially uniform neutral gray appearance. Hence, transmitted intensity of light for a pixel with respect to a negative image would be substantially complementary to transmitted intensity of light for that pixel for a positive image.

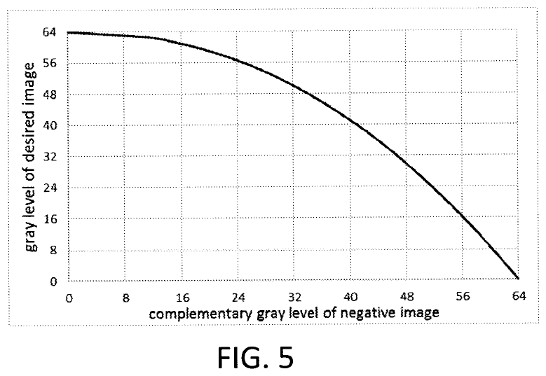

At least in part due to the nonlinear response of the human eye to light intensities, equal incremental amounts in measured light intensity do not correspond to perceived equal incremental amounts in gray levels. For example, for a 6-bit gray scale with 64 distinct gray levels ranging from 0 to 63, a substantially complementary gray level of number n is not simply gray level (63−n) but may be determined from a curve such as shown in FIG. 5. The graph shown in FIG. 5 is for a typical case in which a gamma correction of 2.2 is used, which closely tracks measurements of perceived luminance of a human eye to light intensity. Reading from this graph, if a desired pixel gray level is 32, then a substantially complementary gray level for the same pixel should be 47. Of course, this scheme may not only apply to black and white images but may also apply to color images as well since red, green and blue color channels in an optical display may be treated independently.

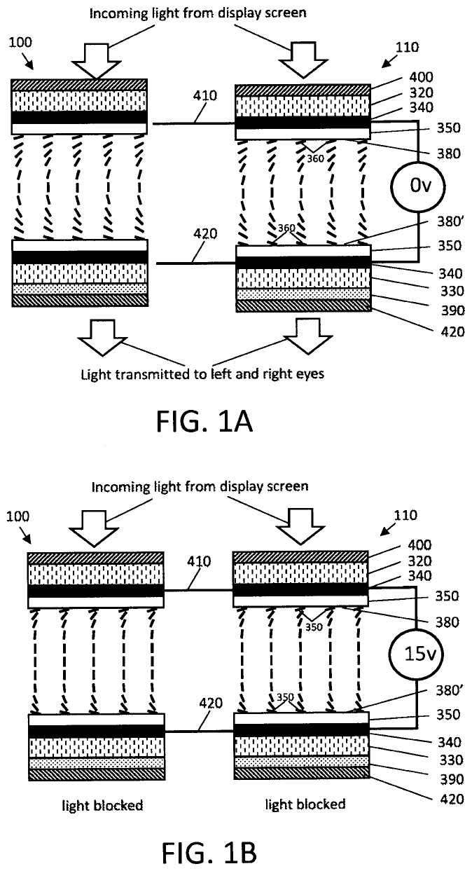

Continuing with a discussion of an illustrative embodiment, FIG. 1A shows a diagrammatic illustration (not to scale) of left and right active light shutter lenses 100 and 110 in a substantially light transmissive state for an eyewear embodiment in accordance with claimed subject matter that uses liquid crystal material with parameters suitable for operation as a pi-cell, such as a low rotational viscosity, for example. Since for this illustration, left and right active light shutter lenses are substantially similar, if not nearly identical, for simplicity, reference numbers in FIGS. 1A and 1B are indicated only on the left active light shutter lens of these FIGs.

An illustration of an active light shutter using a pi-cell has been described by Phillip J. Bos in U.S. Pat. No. 5,187,603. For this illustrative embodiment, a light shutter cell may include two substantially transparent, spaced apart, substantially parallel upper and lower substrates, 320 and 330, respectively illustrated in FIGS. 1A and 1B, which may be made of glass or plastic, whose inner surfaces may be coated with substantially transparent electrodes 340, such as Indium-Tin Oxide (ITO), as one example. Of course, other metallic oxides suitable for substantially transparent electrodes may be used instead or even in combination, such as zinc oxide as an example. Corresponding substantially transparent electrodes 340 of a left eye and a right eye light shutter lenses 100 and 110 may be joined together with conducting wires or strips 410 and 420 to allow left eye and right eye light shutter lenses to operate essentially or effectively (used interchangeably, herein) synchronized via such electrical connections.

Alignment layers 350, such as obliquely deposited SiO₂ or unidirectionally rubbed polyimide coatings, located on substantially transparent electrodes 340 may orient surface-contacting directors 360 of a liquid crystal cell. In this illustrative embodiment, liquid crystal material comprises a nematic type having a positive dielectric constant anisotropy, although claimed subject matter is not limited in scope in this respect. Hence, in this illustrative embodiment, a dielectric constant substantially parallel to the liquid crystal director is larger than a dielectric constant substantially perpendicular to the liquid crystal.

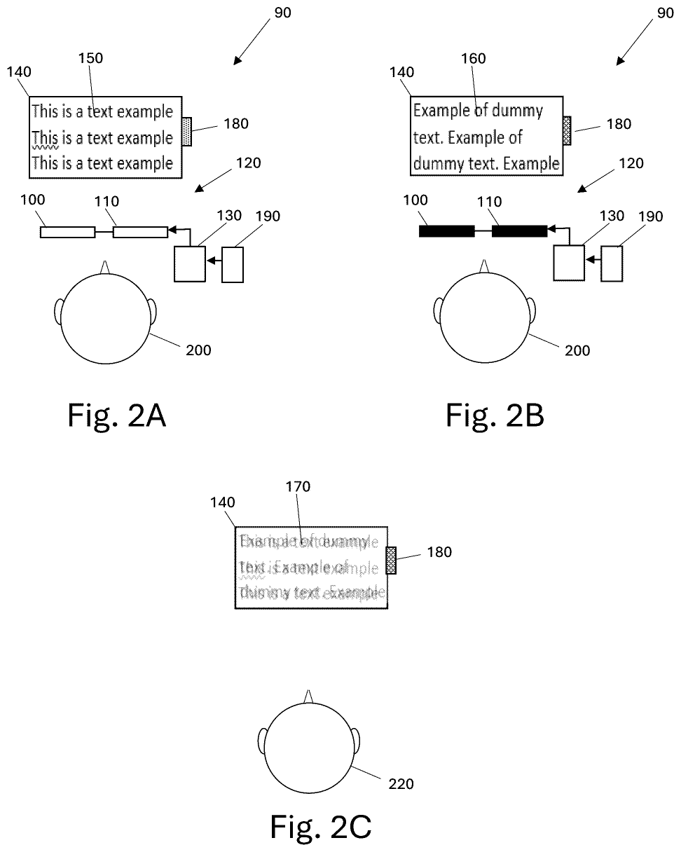

In this example, upper and lower alignment surfaces 380 and 380′ may impart an azimuthal orientation of liquid crystal surface contacting directors 360 making a substantially 45° angle with the plane of the drawings and an out-of-plane orientation of surface contacting directors 360 of a few degrees, referred to as pretilt angle. A retarder film 390 having an in-plane retardation of substantially 30 nm may be positioned under lower substrate 330 with its optical axis substantially perpendicular to an azimuthal direction of surface contacting directors 360. Upper polarizer 400 may, for an illustrative embodiment, transmit substantially vertically polarized light for better throughput if viewing an optical display 140 with a similarly oriented outer polarizer, as was discussed, and as will be discussed in connection FIG. 2. Lower polarizer 420, in an illustrative embodiment, may be crossed with upper polarizer 400 and may transmit substantially horizontally polarized light.

A gap between upper and lower alignment surfaces, here 380 and 380′, may be referred to as cell gap, and in this embodiment comprises a liquid crystal layer. Thickness of a cell gap depends at least in part on birefringence of a particular liquid crystal material used. As described in U.S. Pat. No. 5,187,603, better throughput may be obtained for situations in which the product of the cell gap times the birefringence divided by a design wavelength (typically 540 nm) is around 0.555. For liquid crystal with a birefringence of about 0.129, for example, the cell gap may be around 5.5 μm.

As shown by FIG. 1A, in a 0 v OFF state, a combination of liquid crystal material and compensating retarder 390 may operate as a substantially half-wave retarder at 540 nm that rotates linear polarized light by substantially 90° bringing it substantially parallel to a transmission axis of lower polarizer 420 whereupon light exits lower polarizer 420 with a transmittance designed so that an intended image 150 of intended image content may be observed in this embodiment by both eyes of a viewer, such as viewer 200 discussed below in connection with FIG. 2.

In a 15 v ON state, as depicted in FIG. 1B, liquid crystal directors in the bulk of the liquid crystal layer may be more closely oriented to be substantially perpendicular to substrates 320 and 330 than in a 0 v OFF state. This may decrease effective retardation by a liquid crystal layer in such an embodiment to a point where residual retardation of a pi-cell is small enough to be substantially compensated by a fixed 30 nm retardation of external retarder 390 with a result that there is substantially no rotation of linear polarized light which remains substantially perpendicular to a transmission axis of lower polarizer 420. Thus, light may be absorbed in polarizer 420 and may, thus, substantially block light providing obscuring image content from reaching a viewer, again, such as 200.

In this example, active light shutter lenses 100 and 110 are able to rapidly switch between a substantially light transparency state and a substantially light blocking state with a drive signal from drive electronics 130 that switches between 0 v and 15 v in this illustrative embodiment. For an optical display with a 60 Hz frame rate, a pi-cell generally switches fast enough so that a phenomenon known as “ghosting” should not occur in which a viewer may see a faint image of obscuring image content because active light shutter lenses may not switch to a substantially light blocking state fast enough. Optical displays are now being manufactured with ever-increasing frame rates, such as around 120 Hz and above, to show fast moving objects without motion blur. For these optical displays, a pi-cell may not switch fast enough, and a risk of ghosting may exist. However, for such situations, a faster liquid crystal light shutter lenses may be employed, such as for example, a light shutter lens embodiment using two liquid crystal cells in series to achieve faster switching speeds, as for example described by Jesper Osterman and Terry J. Scheffer in U.S. Pat. No. 8,023,052.

OLED displays may be readily substituted for the LCD used in the above example. Compared with LCDs, OLED displays typically switch at least an order of magnitude faster enabling frame rates of 120 Hz or even 240 Hz or higher.

FIGS. 2A and 2B show schematic diagrams of an illustrative embodiment 90 of a system to handle visual hacking employing an embodiment 120 of eyewear including a pair of active light shutter lenses 100 and 110, respectively, for a left eye and a right eye and drive electronics 130 integrated inside eyewear embodiment 120 so that over alternating time intervals drive electronics 130 may drive both light shutter lenses either into a substantially transparent state or into a substantially light blocking state. During odd frame periods (FIG. 2A), for example, optical display 140 may show a desired image 150 of intended image content with both shutter lenses 100 and 110, for example, in a substantially transparent state, and, during even frame periods (FIG. 2B), optical display 140 may show a dummy image 160 of obscuring image content with both shutter lenses 100 and 110, for example, in a substantially light blocking state. Thus, a viewer, such as 200, wearing eyewear embodiment 120, for example, may see a desired image since a dummy or obscuring image should be substantially blocked, whereas a viewer 220 without eyewear embodiment 120 (FIG. 2C) may see a confusing superposition of both images, as shown by 170, which combines image 150 and image 160.

Of course, it may be desirable for opening (e.g., in a substantially transparent state) and closing (e.g., in a substantially opaque state) of light shutter lenses 100 and 110 to be synchronized with transmission by optical display screen 140 of light for desired and dummy images, 150 and 160, respectively, for example. There are many ways that this may be accomplished and claimed subject matter is not limited in scope to a particular approach. However, as illustrated, a laptop computing device with Bluetooth capability, for example, may send an appropriate signal to a Bluetooth receiver 190 integrated inside eyewear embodiment 120 which may receive the signal and use it to transmit a triggering signal to eyewear drive electronics 130 to maintain synchronization timing for light shutter lenses 100 and 110 to be in a substantially transparent state for a desired image 150 and to be in a substantially light blocking state for a dummy image 160. Alternatively, in another embodiment, a USB plug-in dongle 180, for example, may transmit a synchronizing RF signal to an RF receiver integrated inside eyewear embodiment 120 to establish contact and synchronize with eyewear drive electronics 130. In yet another embodiment, synchronization may also be accomplished by a plug-in USB dongle 180 that transmits an IR signal to be received by an IR sensor at a location on eyewear embodiment 120 facing an LCD, for an embodiment, to then trigger eyewear drive electronics 130. RF or IR plug-in dongles 180 may comprise accessories to be supplied with eyewear embodiment 120, for example.

Selection of intended image content and obscuring image content may, in an embodiment, be handled at least in part by an application (App) programmed to operate in a programable computing device, such as a laptop, a smart cell phone or an electronic tablet, as examples. In an embodiment, such an App may select a first file location where intended image content may logically reside, such as an image 150, and a second file location where obscuring image content may logically reside, such as image 160. These selections in an embodiment may be programmed to be user selections. The App may be executed by a computing device to produce a synchronizing signal to an internal Bluetooth controller or to an external USB port of the computing device to communicate with the previously described RF or IR USB plug-in dongles, in an embodiment. The first file location may include, for example, a text file that an authorized user may, via eyewear embodiment 120, be viewing or working on, such as an email, a report, an Internet image, a video, and/or the like. The second file location may include a file of obscuring image content, such as image 160, designed to create confusion to an unauthorized viewer 220 not wearing eyewear embodiment 120. An unauthorized viewer should see obscuring image content, such as image 160, superimposed upon intended image content, such as image 150, in this illustrative embodiment. As shown in FIG. 2C, as an illustration, resulting superimposed images may be made to appear as unintelligible lines of text.

As suggested, obscuring image content may be made by a user selection, such as via an App, in an embodiment. Likewise, another example, as suggested previously, and potentially also made a user selection, may in an embodiment employ obscuring image content created as a negative image of intended image content so that a visual hacker not wearing suitable eyewear in accordance with claimed subject matter may see a featureless, substantially uniformly gray optical display. A custom designed App, in an embodiment, for example, may be designed, by user selection, to transform intended image content into obscuring image content by forming substantially complementary negative images of intended image content. However, as was mentioned previously, a human eye has a nonlinear response to light intensity. For example, for a 6-bit gray scale with 64 distinct gray intensity levels ranging from 0 to 63,a substantially complementary gray level of number n is not simply gray level (63−n) but may be determined from a curve. FIG. 5 is a graph showing an example of a relationship between gray levels of a desired positive image and gray levels of a substantially complementary negative image. Reading from FIG. 5, if a desired pixel gray level is 32 then a corresponding substantially complementary pixel gray level should be 47. This scheme applies not just to monochrome images, but to color images as well since red, green and blue color channels of an optical display are treated independently.

An embodiment of active light shutter lenses is not limited in scope to the illustration previously discussed. For example, active light shutter lenses may comprise various shapes. Since right eye and left eye lenses are driven substantially in parallel in the previously described illustrative embodiments, two active light shutter lenses 100 and 110 may be consolidated into a single light shutter embodiment wide enough to accommodate both eyes, such as a visual screen or visor, able to filter light to substantially compensate for spatial and/or temporal interleaving, for example, as previously suggested. An embodiment of a light shutter, such as a visual screen or eyewear, using liquid crystal in accordance with claimed subject matter, may also use a variety of liquid crystal modes, such as those previously discussed, including a vertically aligned nematic (VAN) mode, an in-plane switching (IPS) mode, a fringe field switching (FFS) mode, a twisted nematic (TN) mode, a surface stabilized ferroelectric liquid crystal (SSFLC) mode or an optically compensated bend (OCB) mode, as examples.

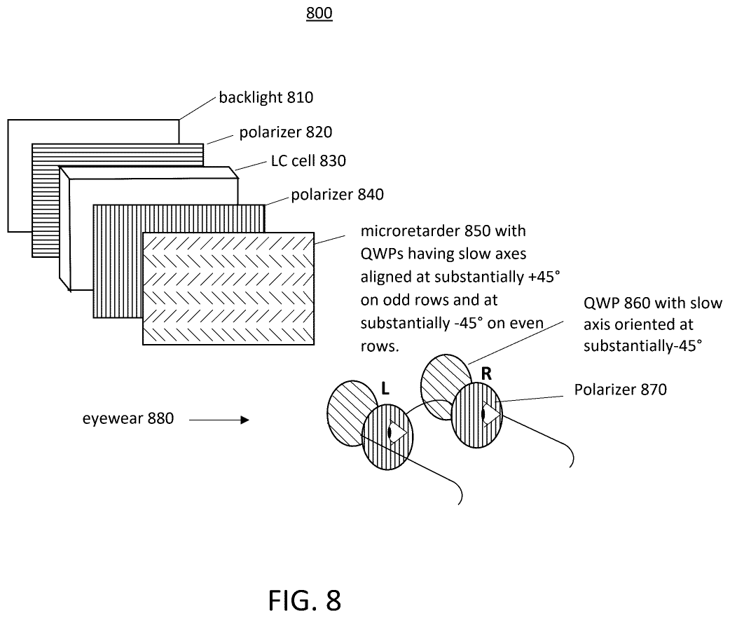

Another illustrative optical display embodiment 800 is depicted by FIG. 8. As previously suggested, embodiments in accordance with claimed subject matter may combine light by interleaving light providing intended image content and light providing obscuring image content in a temporal manner and/or a spatial manner. Illustrative embodiment 800 of FIG. 8 employs spatial interleaving rather than temporal interleaving, the latter of which was described in detail in connection with FIG. 4, for example.

Embodiment 800 of an optical display (e.g., an LCD display) may, for example, comprise an LC cell 830 having rear polarizer 820 letting through substantially horizontally polarized light from backlight 810 and a front polarizer 840 letting through substantially vertically polarized light to be modified by microretarder 850, shown in FIG. 8 as 850. Microretarder 850 may comprise segmented-quarter-wave retarder strips (substantially QWP retarders) positioned over successive rows of pixel components in LC cell 830 with alternating slow axis orientations of substantially +45° over odd numbered rows and substantially −45° over even numbered rows. For the sake of clarity, the width of display rows in FIG. 8 has been greatly exaggerated. In U.S. Pat. No. 7,327,285, Sadeg M. Faris describes methods to manufacture micropolarizers and microretarders and gives an example of manufacturing a microretarder with alternating rows of substantially orthogonal quarter wave retarders (substantially orthogonal QWP retarders) much like as is shown by microretarder 850 in FIG. 8. Another approach to manufacture a microretarder is described by C.T. Lee and H.Y. Lin, “Design and fabrication of wide-view in-cell microretarder & polarizer for stereoscopic LCD,” SID Digest of Technical Papers, pp 1260-1263 (2010). In this publication thin 2 μm strips of substantially half-wave retarders (substantially HWPs retarders) are interleaved with strips of null retarders are manufactured by a polymerization process. This embodiment of a microretarder replaces microretarder 850 and is thin enough to be placed inside an LC cell, such as 830, along with a thin polarizer to replace 840 to substantially expand viewing angle by virtually eliminating parallax that may otherwise be present with an external microretarder for LC cells with thick glass outer substrates. In their publication, C.T. Lee and H.Y. Lin add a substantially QWP retarder sheet (not shown), outside a LC cell 830 with a slow axis substantially orthogonally oriented to strips of substantially half-wave retarders (substantially HWPs retarders) interleaved with strips of substantially null retarders also inside LC cell 830. Thus, as described in Lee and Lin, a combination of a polarizer and substantially HWP strips and null retardation strips inside LC cell and an external substantially uniform QWP retarder sheet results in alternating strips of effectively substantially orthogonal substantially quarter-wave retarder strips (substantially QWP retarders) positioned over successive rows with alternating slow axis orientations of substantially +45° over odd numbered rows and substantially −45° over even numbered rows.

A software modification may implement spatial interleaving of light to provide intended image content on odd numbered display rows and light providing obscuring image content on even numbered display rows. Likewise, as for the illustrative embodiment of temporal interleaving previously described, an App may provide appropriate programming to implement spatial interleaving via a programmable computing device.

In illustrative embodiment 800 of FIG. 8, an image of intended image content may be presented on odd rows of an LCD and an image of obscuring image content may be presented on even rows of an LCD, although claimed subject matter is not limited to illustrative embodiments. For example, a display other than an LCD may be employed. Again, like the previous illustrative embodiment, an unauthorized viewer without appropriate eyewear, such as a visual hacker, would see a confusing superposition of both intended and obscuring image content. Again, in an embodiment, other obscuring image content may be made a user selection, for example, using an App, as described above.

An embodiment 880 of eyewear, illustrated in FIG. 8, may filter spatially interleaved light generated by an optical display, such as an LCD, for example, with microretarder 850 by employing lenses that passively alter the polarization state of incident light to pass intended images and block obscuring images. In comparison with active operation, previously described with respect to active shutter filtering eyewear embodiment 435 where an alternating voltage or current is required to either pass or block incoming light, here, filtering eyewear embodiment 880 comprises lenses that passively alter polarization state of light passing through the particular lens to pass light coming from odd rows and block light coming from even rows without any electrical actuation of eyewear. Eyewear embodiment 880 may accomplish such filtering through a combination of similarly oriented substantially QWP retarders laminated to polarizers provided for respective eyes in eyewear embodiment 880. In this embodiment, a slow axis of substantially QWP retarders on odd rows of microretarder 850 are substantially orthogonal to a slow axis of substantially QWP retarder 860 in eyewear embodiment 880 and, thus, substantially QWP retarders substantially compensate each other allowing substantially vertically polarized light from polarizer 840 to pass through polarizer 870 of eyewear 880. But for even rows, a slow axis of substantially QWP retarders for microretarder 850 are substantially parallel to a slow axis of substantially QWP retarder 860 in eyewear embodiment 880 so that substantially QWP retarders covering even rows of microretarder 850 add to polarization modification by substantially QWP retarder 860 to, in effect, form a substantially half-wave retarder (substantially HWP retarder). A substantially half-wave retarder rotates substantially vertically polarized light from polarizer 840 to a substantially horizontally polarized state where it may be blocked by substantially vertically oriented polarizers 870 of eyewear embodiment 880. Thus, a viewer wearing eyewear embodiment 880 should view desired images presented on odd display rows and should be blocked from viewing obscuring images presented on even display rows.

Another way to comprehend LCD display embodiment 800 and eyewear embodiment 880 is to consider substantially circular polarization properties with respect to substantially QWP/polarizer combinations, such as those in LCD display embodiment 800 and eyewear embodiment 880 of FIG. 8. In this embodiment, a combination of polarizer 840 and substantially QWP microretarders of 850 over odd rows, as previously described, form a left-handed substantially circular polarizer that transmits left-handed substantially circularly polarized light. A polarizer/QWP combination of eyewear polarizers 870 and eyewear substantially QWP retarder 860 also form a left-handed substantially circular polarizer which then allows left-handed substantially circular polarized light transmitted from odd rows of LCD display embodiment 800 to pass through filtering eyewear, such as eyewear embodiment 880, so that intended image content is able to reach a viewer. On the other hand, a combination of polarizer 840 and substantially QWP retarders 850 for even rows of LCD display embodiment form a right-handed substantially circular polarizer that transmits right-handed substantially circularly polarized light. Thus, light carrying obscuring image content is substantially blocked by a substantially QWP/polarizer combination of substantially QWP retarder 860 and polarizer 870 in eyewear embodiment 880. Because of left- and right-handed substantially circular polarization of light leaving LCD display embodiment 800, a viewer wearing eyewear embodiment 880 could tilt or move his or her head to a comfortable position, without substantially affecting substantially light transmitting and/or substantially light blocking properties, as just described with respect to eyewear embodiment 880. A visual hacker without eyewear embodiment 880 would see a confusing superposition of intended and obscuring image content. This previous statement also applies to a visual hacker wearing standard polarized sunglasses regardless of head tilt, even if by substantially 90°, for example. In a safe environment with no visual hackers present, intended images may be viewed in full resolution without eyewear by transmitting light for intended images via odd and even rows, rather than via odd rows for light with intended images and via even rows for light with obscuring images. Similar gray scale considerations as mentioned in connection with the previously described illustrative embodiment in which light may be temporally interleaved, rather than spatially interleaved, may also apply here.

Embodiment 800, such as illustrated by FIG. 8, for example, may be varied to produce embodiments which may provide substantially equivalent performance. Such embodiments are included within the scope of claimed subject matter. For example, by swapping positions of front and rear polarizers 840 and 820 and rotating polarization direction of eyewear polarizer 870 by substantially 90°, an observer will continue to view intended images on odd rows and be blocked from viewing obscuring images on the even rows. As another example, light transmitted via even display rows instead of odd display rows may provide intended image content. For this case, a slow axis of eyewear embodiment retarders, such as 860, may be rotated by substantially 90°. Likewise, as another alternative, an embodiment may spatially interleave light using microretarders by aligning substantially QWP retarders at substantially +45° on odd columns and substantially −45° on even columns, thereby changing orientation of slow axes for substantially QWP retarders on immediately adjacent columns of an optical display by substantially 90° and affecting light passing through immediately adjacent columns rather than immediately adjacent rows. Likewise, in yet another alternative embodiment, spatially interleaving light that respectively corresponds to intended image content and to obscuring image content may be implemented by altering relative slow axis orientation of substantially QWPs between immediately adjacent pixels of an optical display in a vertical and in a horizontal direction by substantially 90°. As mentioned earlier, a polarizer 840 and a microretarder, as described in an aforementioned publication by Lee and Lin, may be placed inside an LC cell, such as 830, for example, on top of color filters. Configuration embodiments, such as examples as described above, are applicable to embodiments for monochrome grayscale images as well as to embodiments for color images.

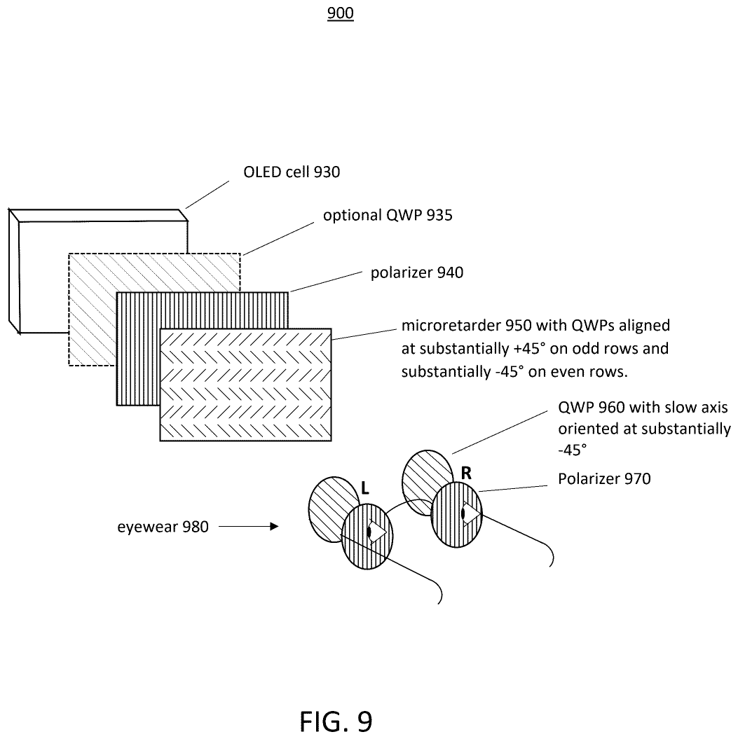

Embodiment 900 may, for example, comprise an OLED cell or micro-LED cell 930, (going forward it shall be understood that “OLED” refers to “OLED and/or micro-LED”) as illustrated in FIG. 9. Since OLED displays are emissive displays, they do not use backlights or rear polarizers. In illustrative OLED display embodiment 900, a polarizer 940 and microretarder 950 may be included on top of OLED cell 930. Similar to illustrative embodiment 800 for an LCD shown in FIG. 8, microretarder 950 may comprise substantially quarter-wave retarder strips having alternate substantially +45° and substantially −45° slow axis orientations positioned over successive rows of pixel components of OLED cell 930. For the sake of clarity, the width of display rows in FIG. 9 have been greatly exaggerated.

In OLED display embodiment 900, intended image content may be displayed on odd rows of OLED display 930, and obscuring image content may be displayed on even rows of OLED display 930. Again, like the previous illustrative embodiment 800 for an LCD, without appropriate eyewear, an unauthorized viewer, such as a visual hacker, should see a confusing superposition of both intended and obscuring image content. Again, in an embodiment, obscuring image content may be made a user selection, for example, via an App, as described above.

An eyewear embodiment 980, illustrated in FIG. 9, may filter spatially interleaved light generated by an OLED display, such as embodiment 900, with a microretarder sheet 950 by employing eyewear that is able to passively alter a polarization state of incident light to substantially pass intended images and to substantially block obscuring images. Eyewear embodiment 980 may accomplish this filtering through a combination of similarly oriented substantially QWP retarders and polarizers. In this embodiment, a slow axis of substantially QWP retarders on odd rows of microretarder 950 are substantially orthogonal to a slow axis of substantially QWP retarder 960 of eyewear embodiment 980 and, thus, substantially QWP retarders 950 and 960 substantially compensate each other to allow substantially vertically polarized light from polarizer 940 to pass through polarizer 970 of eyewear embodiment 980 to a viewer. For even rows, substantially QWP retarders on microretarder 950 include a slow axis substantially parallel to a slow axis of substantially QWP retarder 960 so that retardation of substantially QWP retarders on microretarder 950 for even rows of microretarder 950 adds to retardation of substantially QWP retarder 960 of eyewear embodiment 980 to form a substantially half-wave retarder (substantially HWP retarder). A substantially half-wave retarder rotates substantially vertically polarized light from polarizer 940 to a substantially horizontally polarized state where it may be blocked by substantially vertically oriented polarizers 970 of eyewear embodiment 980. Thus, a viewer wearing eyewear embodiment 980 should view intended images addressed on odd display rows via light substantially passing through polarizer 970 and should be substantially blocked by polarizer 970 from viewing obscuring images addressed on even rows.

Another way of understanding the above is to consider substantially circular polarization properties of substantially QWP retarder/polarizer combinations, such as those in OLED display embodiment 900 of FIG. 9. In this embodiment, a combination of polarizer 940 and microretarder 950 may form a left-handed substantially circular polarizer that is able transmit light emitted by odd rows of OLED display embodiment 900 as left-handed substantially circularly polarized light from OLED display embodiment 900. A substantially QWP retarder/polarizer combination of polarizer 970 and substantially QWP retarder 960 also form a left-handed substantially circular polarizer which allows transmission of left-handed substantially circularly polarized light, such as substantially circularly polarized light for intended images from odd rows of OLED display embodiment 900, to pass intended images through polarizer 970 and substantially QWP retarder 960 to a viewer. On the other hand, a combination of polarizer 940 and substantially QWP retarders of microretarder 950 over even rows of OLED display embodiment 900 form a right-handed substantially circular polarizer that is able to transmit right-handed substantially circularly polarized light from OLED display embodiment 900. Thus, light carrying obscuring images may be substantially blocked by a left-handed substantially circular polarizer formed by a combination of substantially QWP retarder 950 and polarizer 970 in eyewear embodiment 980. Because of left-and right-handed substantially circular polarization of light leaving OLED display embodiment 900, a viewer wearing eyewear embodiment 980 may tilt his or her head to a comfortable position without substantially affecting substantially light transmitting and/or substantially light blocking properties. A visual hacker without eyewear 980 should see a confusing superposition of intended and obscuring images. This also applies to a visual hacker wearing polarized sunglasses regardless of head tilt, even by substantially 90°, for example. In a safe environment with no visual hackers present intended images can be viewed in full resolution without eyewear by writing odd as well as even rows of OLED display embodiment with intended images. Similar gray scale considerations as mentioned in connection with previously described illustrative embodiment 400 of FIG. 4, for example, in which light may be temporally interleaved, rather than spatially interleaved, may also apply here.

Embodiment 900, as illustrated by FIG. 9, has many possible embodiments with variations which may nonetheless provide substantially equivalent performance. For example, equivalent performance may be achieved by rotating both polarizer 940 of OLED display embodiment 900 and polarizer 970 of eyewear embodiment by substantially 90°. In another example, intended image content may be emitted by light from even display rows instead of light from odd display rows if retarders 960 of eyewear embodiment 980 are rotated by substantially 90°. Likewise, as another alternative, an embodiment may spatially interleave light using microretarders by aligning QWP retarders at substantially +45° on odd columns and substantially −45° on even columns, thereby changing orientation of slow axes for substantially QWP retarders on immediately adjacent columns of an optical display by substantially 90° and affecting light passing through immediately adjacent columns rather than immediately adjacent rows. Likewise, in an alternative embodiment, spatially interleaving light that respectively corresponds to intended image content and to obscuring image content may be implemented by rotating by substantially 90° the relative orientation of substantially QWP retarders in immediately adjacent pixels in a vertical and in a horizontal direction of OLED display embodiment 900, such as, for example, aligning QWP retarders at substantially +45 for a particular pixel and aligning QWP retarders at substantially −45° for immediately adjacent pixels in a vertical and in a horizontal direction of the particular pixel. As mentioned earlier for LCDs, likewise, for an OLED display, such as embodiment 900, to reduce parallax error, a polarizer 940 and a microretarder, as described in an aforementioned publication by Lee and Lin, may be placed inside an OLED cell, such as 930, for example, or they may alternately, for example, be placed external to an OLED cell, such as 930, by, for example, being laminated outside of a front substrate of an OLED cell, such as 930, along with a microretarder of substantially QWP retarders, such as 950, as was described.

Some OLED displays may deploy a substantially circular polarizer in front of the OLED cell of the display. For example, a substantially circular polarizer may suppress reflections of ambient light that may otherwise reflect from a rear electrode. If ambient light reflections were returned to a viewer, a contrast ratio for the OLED display may be adversely affected. This type of substantially circular polarizer may include a substantially QWP retarder 935 placed, for example, directly in front of OLED cell 930 with a slow axis at either substantially +45° or substantially −45° to a transmission axis of polarizer 940. Ambient light becomes substantially circular polarized after passing through polarizer 940 and substantially QWP retarder 935 and changes handedness upon reflection from an OLED rear electrode and subsequently becomes substantially horizontally polarized light after a return path through substantially QWP retarder 935 which may then be absorbed by polarizer 940, in an embodiment. If ambient light rejection is not employed, as just described, optional substantially QWP retarder 935 may be omitted. Either way, substantially QWP retarder 935, whether present or not, has no effect on operation of embodiment 900 with respect to visual hacking since an OLED cell, such as 930, emits unpolarized light that remains unpolarized whether or not optional substantially QWP retarder 935 is included immediately adjacent OLED cell 930, for example.

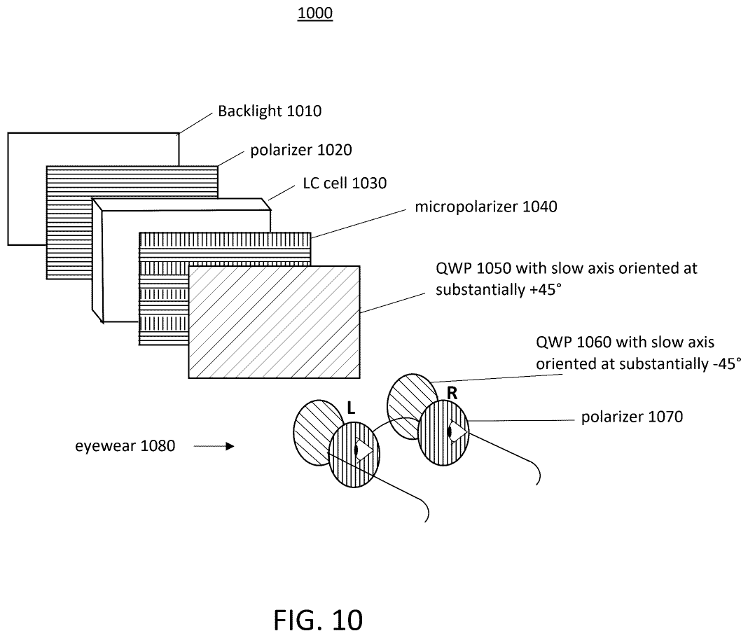

As previously suggested, embodiments in accordance with claimed subject matter may combine light by interleaving light providing intended image content and light providing obscuring image content in a temporal manner and/or a spatial manner. Illustrative embodiment 1000 of FIG. 10 employs spatial interleaving rather than temporal interleaving and, consequently, takes advantage of a resolution limit of a human eye rather than taking advantage of persistence of vision as in temporal interleaving.

LCD embodiment 1000 is depicted in FIG. 10 and may include an LC cell 1030 having rear polarizer 1020 to modify light from backlight 1010 so that substantially horizontally polarized light may be transmitted to LC cell 1030. In an embodiment, LC cell 1030 may be followed by micropolarizer 1040. Micropolarizer 1040, in an embodiment, may comprise a linear polarizer that includes micropolarizing components with substantially vertical transmission axes over odd numbered pixel rows of LC cell 1030 and includes micropolarizing components with substantially horizontal transmission axes over even numbered pixel rows of LC cell 1030. For the sake of clarity, the width of display rows in FIG. 10 has been greatly exaggerated.

For an illustrative embodiment, such as LCD embodiment 1000, following micropolarizer 1040 may comprise a substantially QWP retarder 1050 with a slow axis oriented at substantially +45°. As depicted in FIG. 10, lenses in eyewear embodiment 1080, in this embodiment, are substantially the same for both left and right eyes and include a substantially QWP retarder 1060 facing LC cell 1030 with a slow axis oriented at substantially −45° followed by a polarizer 1070 with a substantially vertical transmission axis.

The operation of illustrative LCD display embodiment 1000 and illustrative eyewear embodiment 1080 may be understood by considering two polarizer/substantially QWP retarder combinations depicted in FIG. 10, namely micropolarizer 1040 and substantially QWP retarder 1050 in LCD display embodiment 1000 and eyewear polarizer 1070 and eyewear substantially QWP retarder 1060 in eyewear embodiment 1080. Substantially QWP retarder 1050 may transform substantially vertically polarized light passing through odd rows of micropolarizer 1040 into left-handed substantially circularly polarized light, and QWP 1050 may transform substantially horizontally polarized light passing through even rows of micropolarizer 1040 into right-handed substantially circularly polarized light. Substantially QWP retarder 1060 of eyewear embodiment 1080 may transform incoming left-handed substantially circularly polarized light, which may carry intended images in an embodiment, into substantially vertically polarized light that is able to pass through substantially vertically oriented polarizer 1070 so that intended images are able to reach a viewer. On the other hand, right-handed substantially circular polarized light passing through even rows of micropolarizer 1040, carrying obscuring images, may be transformed into substantially horizontally polarized light after passing through substantially QWP retarder 1060 where it may be blocked by substantially vertically oriented polarizer 1070. Obscuring image content consequently does reach a viewer. Furthermore, because left-and right-handed substantially circular polarization of light passing through odd and even rows of substantially QWP retarder 1050, a viewer wearing eyewear embodiment 1080 may tilt his or her head to a comfortable position without substantially affecting substantially light transmitting and/or substantially light blocking properties of illustrative LCD display embodiment 1000 and eyewear embodiment 1080. Without eyewear embodiment 1080, a visual hacker should see a confusing superposition of intended images and obscuring images, even for someone wearing polarized sunglasses and regardless of the degree of head tilt

In U.S. Pat. No. 7,327,285, Sadeg M. Faris describes methods to manufacture micropolarizers and gives an example of manufacturing a polarizer with alternating rows of polarizer strips with substantially orthogonal polarization directions like that of micropolarizer 1040 shown in FIG. 10. Likewise, in another embodiment, to reduce parallax effects between a micropolarizer and pixels of an optical display, such as an LCD display, that may be introduced due at least in part to thickness of a front substrate plate of an LC cell, such as 1030, it is also possible to place a micropolarizer inside an LC cell, such as 1030, in close proximity to pixels of LC cell 1030, for example, as has been demonstrated by S.J. Lee et al., “A wire grid stereoscopic display”, SID Digest of Technical Papers, pp 89-92 (2006).

A software modification may implement spatial interleaving of light providing intended image content and light providing obscuring image content on alternate rows of an LCD display, such as embodiment 1000. Likewise, here, as was the case for temporal interleaving, an App may provide appropriate programming to implement spatial interleaving via a programmable computing device, again, as was previously described for temporal interleaving.

Thus, in an embodiment of an App, obscuring image content may be made a user selected option with a variety of possibilities. For example, with respect to intended image content that is primarily text-based, obscuring image content may comprise one of a multitude of patterns. For example, patterns are used inside security envelopes so that even if someone were to hold such an envelope up to a light 3 read text-based content inside the envelope, the text-based content would be obscured. Another of many potential possibilities for obscuring image content, especially for photographs, may comprise passing light carrying image content that is complementary to intended image content through even rows, for example, of an LCD display embodiment, such as 1000.

For illustrative embodiment 1000, there is no need to separately generate complementary obscuring image content, such as may be passed through even rows, as described above. Rather, in an embodiment, complementary image content may be a byproduct of generating image content between two substantially parallel polarizers, such as, for example, polarizer 1020 and even rows of micropolarizer 1040. Likewise, in an embodiment, such as described, in which intended image content may pass through odd rows of micropolarizer 1040, this intended image content may be generated between two crossed polarizers, such as polarizer sheet 1020 and odd rows of micropolarizer 1040, in this illustrative embodiment. This intrinsic, complementary effect may be explained as follows: substantially horizontally polarized light after passing through a birefringent liquid crystal layer inside an LC cell, such as 1030, is generally elliptically polarized with a certain ellipticity having a major axis for respective wavelengths of light. Elliptically polarized light may be decomposed with polarization filters along substantially vertical and substantially horizontal axes. Thus, any components of elliptically polarized light that lie along a substantially vertical axis should pass through substantially vertical polarizers of micropolarizer 1040. Likewise, any components of elliptically polarized light that lie along a substantially horizontal axis should pass through substantially horizontal polarizers of micropolarizer 1040. However, polarized light passed through a substantially vertical polarization filter passes polarized light that lies along a substantially vertical axis and polarized light passed through a substantially horizontal polarization lies along a substantially horizontal axis. Adding the intensity of the light that passes through these filters produces light having an intensity that corresponds to the intensity of the elliptical polarized light. Consequentially, images produced by these respective filters are complementary. In other words with this embodiment, the obscuring image content is generated “automatically” so that the superposition of the light from the odd and even rows will produce a substantially uniform featureless gray image.

A viewer wearing eyewear embodiment 1080 should view intended images presented on odd display rows that substantially pass through lenses of eyewear embodiment 1080. Likewise, a viewer wearing eyewear embodiment 1080 should be substantially blocked from seeing obscuring images presented on even display rows. Without filtering eyewear, a visual hacker would see a superposition of intended image content on odd rows with obscuring image content on even rows. Furthermore, resolution of an LCD display embodiment, such as 1000, generally has a higher resolution than resolution of an unaided human eye at normal viewing distances. In such a situation, a human eye is not capable of distinguishing individual adjacent rows of an LCD display embodiment, such as 1000. A visual hacker, therefore, would see a blurry, superposition of adjacent rows as a substantially featureless gray field over the LCD display embodiment assuming complementary images for intended and obscuring image content. This would also be the case for a hacker wearing polarized sunglasses regardless of any head tilting. In a safe environment with no visual hackers present, intended image content may be viewed in full resolution without eyewear by generating intended image content for odd and for even pixel rows. But in this case, to generate intended image content for even rows, the complement of intended image content may be generated for even rows using similar grayscale considerations as mentioned in connection with an illustrative embodiment in which light may be temporally interleaved, rather than spatially interleaved. For example, generate a complement of the automatically generated complementary image to appear on even rows, in an illustrative embodiment.

Embodiment 1000, such as illustrated by FIG. 10, for example, has many possible embodiments with variations which may nonetheless provide substantially equivalent performance. For example, by replacing substantially QWP retarder 1050 with a slow axis of substantially +45° to one with a slow axis of substantially −45° and replacing substantially QWP retarder 1060 with slow axis of substantially −45° to one with a slow axis of substantially +45°, an observer would continue to view intended image content on odd rows and be substantially blocked from viewing obscuring image content on even rows. In another embodiment, intended image content may be carried by light transmitted from even display rows instead of light transmitted from odd display rows. For this case, for example, rear polarizer 1020 with a substantially horizontal polarization axis may be replaced with one with a substantially vertical polarization axis, and eyewear polarizer 1070 with a substantially vertical polarization axis may be replaced by a polarizer with a substantially horizontal polarization axis. Likewise, embodiments may spatially interleave light using micropolarizers by rotating polarization direction of immediately adjacent columns of micropolarizer 1050 by substantially 90° instead of rotating polarization direction of immediately adjacent rows of micropolarizer 1050 by substantially 90. Likewise, spatially interleaving light that respectively corresponds to intended image content and to obscuring image content may be implemented for a particular pixel of an LCD display by rotating by substantially 90° polarization direction in immediately adjacent pixels in a vertical and in a horizontal direction of an LCD display, such as 1000, thus forming a checkerboard pattern as illustrated by Sadeg M. Faris in U.S. Pat. No. 7,327,285. Still other variations are possible, but it should be kept in mind that to view intended image content with sufficiently high contrast ratio over a wide range of visible wavelengths, a polarization axis of rear polarizer 1020 should be substantially orthogonal to a polarization axis of micropolarizer portions of micropolarizer 1040 that are over pixels passing light for intended image content. For this case, a sufficiently dark state occurs for an LCD cell of essentially zero retardation over a wide range of visible wavelengths. Configuration embodiments above are applicable to monochrome grayscale images as well as color images.

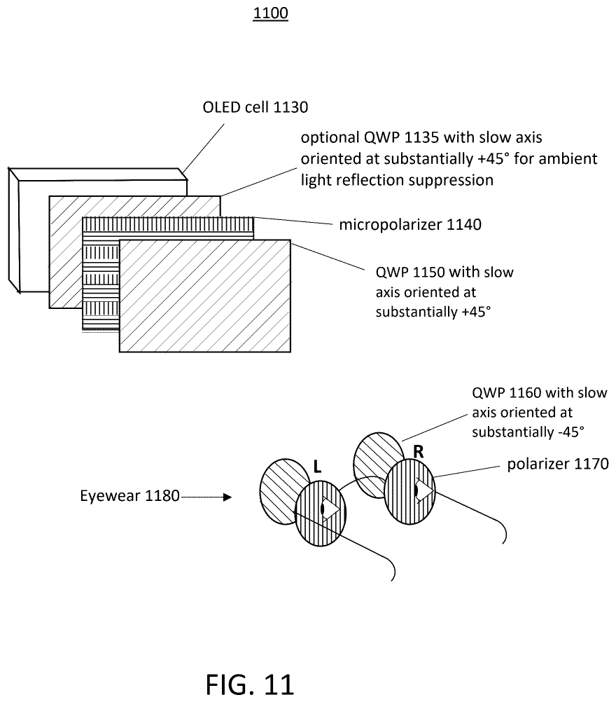

Illustrative OLED (or micro-LED) display (hereinafter “OLED” is understood to refer to “OLED” and/or “micro-LED”) embodiment 1100 is depicted in FIG. 11. For example, embodiment 1100 may comprise an OLED cell 1130 with an optional substantially QWP retarder 1135 with a slow axis oriented at substantially +45 followed by a micropolarizer 1140 and substantially QWP retarder 1150 with a slow axis oriented at substantially +45°. Details of a micropolarizer, such as 1140, have been discussed previously in illustrative embodiment 1000. Since OLED displays are emissive displays, a backlight or a rear polarizer may be omitted. Like illustrative embodiment 1000 for an LCD display, micropolarizer 1140 may include polarizer strips with alternating substantially orthogonal polarization axes that are substantially vertical over odd rows and substantially horizontal over even rows. For the sake of clarity, the width of display rows depicted in FIG. 11 have been greatly exaggerated. As depicted in FIG. 11, lenses in eyewear embodiment 1180 have substantially the same orientation for respective eyes and include a substantially QWP retarder 1160 with a slow axis oriented at substantially −45° facing OLED cell 1130 followed by a polarizer 1070 with a substantially vertical transmission axis.

Operation of illustrative embodiment 1100 may be understood by considering polarizer/substantially QWP retarder combinations depicted in FIG. 11, here, one combination comprising micropolarizer 1140 and substantially QWP retarder 1150, and another combination comprising polarizer 1170 and substantially QWP retarder 1160. Substantially QWP retarder 1150 transforms substantially vertically polarized light carrying intended image content and transmitted through odd rows of micropolarizer 1140 into left-handed substantially circularly polarized light, and transforms substantially horizontally polarized light carrying obscuring image content and transmitted through even rows of micropolarizer 1140 into right-handed substantially circular polarized light. Substantially QWP retarder 1060 of eyewear embodiment 1180 transforms incoming left-handed substantially circularly polarized light into substantially vertically polarized light that passes through substantially vertically oriented polarizer 1170 so that intended image content is able to reach a viewer. In contrast, right-handed substantially circularly polarized light transmitted through even rows of micropolarizer 1140 are transformed into substantially horizontally polarized light after passing through substantially QWP retarder 1160 and, therefore, is substantially blocked by substantially vertically oriented polarizer 1170. Hence, obscuring image content is substantially blocked from reaching a viewer. Furthermore, because of left-and right-handed substantially circular polarization of light transmitted through substantial QWP retarder 1150, a viewer wearing eyewear embodiment 1180 could tilt his or her head to a comfortable position without substantially affecting substantially light transmitting and/or substantially light blocking properties of illustrative embodiment 1100. Without eyewear embodiment 1180, a visual hacker should see a confusing superposition of intended and obscuring image content, even for someone wearing polarized sunglasses regardless of how far his or her head was tilted.

A software modification may implement spatial interleaving of light providing intended image content and light providing obscuring image content on alternate rows of an OLED display, such as embodiment 1100. Likewise, as for an illustrative embodiment of temporal interleaving, an App may provide appropriate programming to implement spatial interleaving via a programmable computing device, as was previously described for a temporal interleaving embodiment.

Again, in an embodiment, obscuring image content may be made a user selected option, and there are a wide variety of possibilities. For intended image content that is primarily text-based, for example, obscuring image content may comprise one of a multitude of patterns. For example, patterns found inside security envelopes obscure text-based content so that someone trying to read the contents inside an envelope without opening are not able to do so. Another example out of many possibilities for an obscuring image, especially for video images, may comprise creating negative, or complementary, image content of intended image content. Thus, intended image content passes through odd rows of micropolarizer 1040 and complementary image content passes through even rows of micropolarizer 1040.

A viewer wearing eyewear embodiment 1180 should see intend image content presented on odd rows of an OLED display embodiment, such as 1100, and should be blocked from viewing complementary image content presented on even rows of an OLED display embodiment, such as 1100. Without eyewear embodiment 1180, a visual hacker, however, should see a superposition of intended image content on odd rows and complementary image content on even rows. In an embodiment, such as 1100, resolution is generally higher than the resolution of an unaided human eye at normal viewing distances. Hence, an unaided human eye is not capable of distinguishing individual adjacent rows of an OLED display embodiment, such as 1100, and a visual hacker should see a blurry superposition of adjacent rows forming a substantially featureless gray field over the entire display. This would also be the case for a hacker wearing polarized sunglasses regardless of any head tilting. In a safe environment with no visual hackers present, intended image content may be viewed in full resolution without eyewear by providing intended image content on odd and even pixel rows, rather than providing complementary image content on even pixel rows, in an embodiment.

Some OLED displays may deploy a substantially circular polarizer comprising a substantially QWP retarder and a substantially uniform linear polarizer, such as in front of an OLED display embodiment to suppress ambient light reflecting from a rear electrode of an OLED cell, such as OLED cell 1130. Otherwise, without a filter, ambient light may return to a viewer and degrade a contrast ratio of the OLED display. This suppression also works if the polarizer is replaced by a micropolarizer, such as 1040, as depicted in FIG. 10. Rather, whether the polarization state of ambient light passing through microretarder 1140 is right or left substantially circularly polarized does not affect spatial interleaving, as discussed with respect to embodiment 1100. In either case, substantially circularly polarized light changes its handedness after being reflected from an OLED electrode and, thus, in an embodiment reflected light may be blocked on a return path through micropolarizer 1040, for example. If ambient light suppression is not employed, optional substantially QWP retarder 1135 may be omitted as it has no effect on spatial interleaving performed by embodiment 1100. OLED cell 1030, for example, emits unpolarized light and remains unpolarized whether or not an optional substantially QWP retarder 1135 is included adjacent to OLED cell 1030, for example, as part of a light path.

Embodiment 1100, such as illustrated by FIG. 11, for example, has many possible embodiments with variations which may nonetheless provide substantially equivalent performance. For example, by replacing substantially QWP retarder 1150 with a slow axis of substantially +45° to one with a slow axis of substantially −45° and replacing substantially QWP retarder 1160 with a slow axis of substantially −45° to one having a slow axis of substantially +45°, an observer should view intended image content on odd rows and be substantially blocked from viewing obscuring image content, such as complementary image content, on even rows. In another embodiment, for example, intended image content may be carried by light transmitted from even display rows instead of by light transmitted by odd display rows. For this case, eyewear embodiment polarizer 1170 with a substantially vertical polarization axis may be replaced by a polarizer with a substantially horizontal polarization axis. Likewise, embodiments may spatially interleave light using micropolarizers by changing polarization direction of immediately adjacent columns of micropolarizer 1040 by substantially 90° instead of doing so for immediately adjacent rows of micropolarizer 1040. Still other variations are possible. For example, spatially interleaving light that respectively corresponds to intended image content and to obscuring image content may be implemented for a particular pixel, rotating by substantially 90° the polarization direction for immediately adjacent pixels in a vertical and in a horizontal direction, thus forming a checkerboard pattern as illustrated by Sadeg M. Faris in U.S. Pat. No. 7,327,285. The above embodiment configurations are applicable to monochrome grayscale images as well as color images.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components, illustrated, for example, in FIGS. 1A and 1B by 410 and 420. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, may also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, may be present between the substance deposited and the substrate so that the substance deposited is not necessarily in direct physical and tangible contact with the substrate.

A similar distinction is made in an appropriate context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular and/or the plural, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall within the abstract idea judicial exception to statutory subject matter and/or patent eligibility. Rather, it is asserted that physical measurements are not mental steps and, likewise, are not abstract ideas.

A given measurement may not be a perfect measurement; however, in general, it is expected that on average one or more measurements may better reflect an underlying deterministic component, for example, if random components that may be included in one or more obtained measurements, are considered. Practically speaking, of course, it is desirable to be able to generate a physically meaningful model of processes affecting measurements to be taken.

The terms “measurement,” “measurement vector,” and/or “vector” may used throughout this document interchangeably. In an embodiment, a vector, or portion thereof, comprising one or more measurements may be associated with signal values and/or signal sample values, which may also be stored as physical states, such as memory states. That is, without loss of generality, substantially in accordance with the foregoing description and/or later description, physical measurements are understood to exist as physical signals and/or physical signal samples, which, again, may be stored as physical states, such as memory states.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

In the context of the present patent application, the terms “content,” “digital content,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content may be provided to a user in a form so that the user is able to readily perceive the underlying content itself (e.g., content presented in a form consumable by a human, such as hearing audio, feeling tactile sensations and/or seeing images, as examples).

Typically, memory states, for example, comprise tangible components, whereas physical signals are not necessarily tangible, although signals may become (e.g., be made) tangible, such as by appearing on a tangible optical display, for example, as is not uncommon. Also, for one or more embodiments, components may comprise a graphical object, such as, for example, an image, such as a digital image, and/or sub-objects, including attributes thereof, which, again, comprise physical signals and/or physical states (e.g., capable of being tangibly displayed). In an embodiment, content, such as digital content, may comprise, for example, text, images, audio, video, and/or other types.

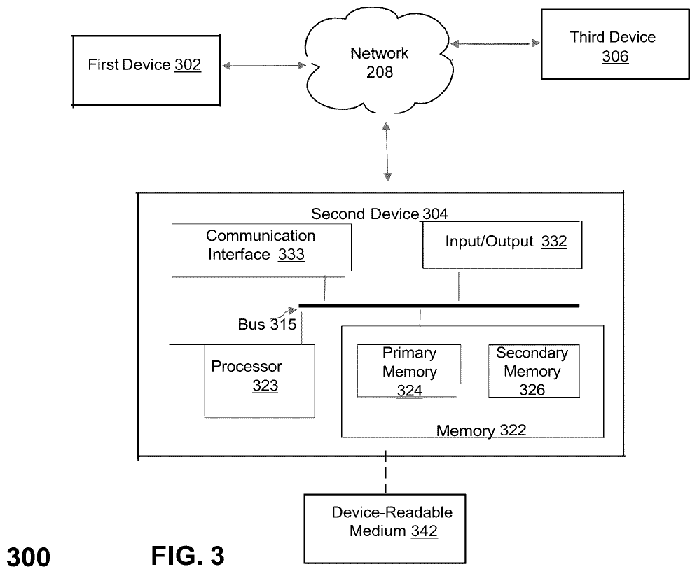

In one example embodiment, as shown in FIG. 3, a system embodiment may comprise a local network (e.g., computing device 304 and non-transitory storage medium 342) and/or another type of network, such as a computing and/or communications network. For purposes of illustration, therefore, FIG. 3 shows an embodiment 300 of a system that may be employed to implement either type or both types of networks. Network 208 may comprise one or more network connections, links, processes, services, applications, and/or resources to facilitate and/or support communications, such as an exchange of communication signals, for example, between a computing device, such as 302, and another computing device, such as 306, which may, for example, comprise one or more client computing devices and/or one or more server computing device. By way of example, but not limitation, network 208 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 3 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor,” for example, is understood to connote a specific structure such as a central processing unit (CPU) of a computing device which may include a control unit and an execution unit. In an aspect, a processor may comprise a device that interprets and executes instructions to process input signals to provide output signals. As such, in the context of the present patent application at least, computing device and/or processor are understood to refer to sufficient structure within the meaning of 35 USC § 112(f) so that it is specifically intended that 35 USC § 112(f) not be implicated by use of these and/or similar terms; however, if it is determined, for some reason not immediately apparent, that the foregoing understanding cannot stand and that 35 USC § 112(f), therefore, necessarily is implicated by such terms, then, it is intended, pursuant to that statutory section, that corresponding structure, material and/or acts for performing one or more operations be understood and be interpreted to be described at least in FIG. 3 and in the text associated with the foregoing figure of the present patent application.

Referring now to FIG. 3 in an embodiment, first and third computing devices 302 and 306 may be capable of rendering a graphical user interface (GUI) for a network device and/or a computing device, for example, so that a user-operator may engage in system use. Computing device 304 may potentially serve a similar function in this illustration. Likewise, in FIG. 3, computing device 302 (‘first device’ in figure) may interface with computing device 304 (‘second device’ in figure), which may, for example, also comprise features of a client computing device and/or a server computing device, in an embodiment. Processor (e.g., processing device) 323 and memory 322, which may comprise primary memory 324 and secondary memory 326, may communicate by way of a communication bus 315, for example. The term “computing device,” in the context of the present patent application, refers to a system and/or a device, such as a computing apparatus, that includes a capability to process (e.g., perform computations) and/or store digital content, such as measurements, text, images, video, audio, etc. in the form of signals and/or states. Thus, a computing device, in the context of the present patent application, may comprise hardware, software, firmware, or any combination thereof (other than software per se). Computing device 304, as depicted in FIG. 3 is merely one example, and claimed subject matter is not limited in scope to this particular example.

For one or more embodiments, a computing device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device, such as a computing device, may include a numeric keypad and/or other display of limited functionality, such as a monochrome liquid crystal display (LCD) for displaying text and other content, for example. In contrast, however, as another example, a web-enabled computing device may include a physical and/or a virtual keyboard, mass storage, one or more accelerometers, one or more gyroscopes, a global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX).

A computing and/or network device may include and/or may execute a variety of now known and/or to be developed operating systems, including derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, and/or Flickr, to provide only a few examples. A computing and/or network device may also include executable computer instructions to process and/or communicate content, such as, digital content, which may include, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 3, computing device 302 may provide one or more sources of executable computer instructions in the form physical states and/or signals (e.g., stored in memory states), for example. Computing device 302 may communicate with computing device 304 by way of a network connection, such as via network 208, for example. As previously mentioned, a connection, while physical, may not necessarily be tangible. Although computing device 304 of FIG. 3 shows various tangible, physical components, claimed subject matter is not limited to a computing device having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 322 may comprise any non-transitory storage mechanism. Memory 322 may comprise, for example, primary memory 324 and secondary memory 326, additional memory circuits, mechanisms, or combinations thereof may be used. Memory 322 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 322 may be utilized to store a program of executable computer instructions. For example, processor 323 may fetch executable instructions from memory and proceed to execute the fetched instructions. Memory 322 may also comprise a memory controller for accessing a non-transitory storage medium, such as an article comprising computer (or other device) readable-medium 342, that may carry and/or make accessible digital content, which may include code, and/or instructions, for example, executable by processor 323 and/or some other device, such as a controller, as one example, capable of executing computer instructions, for example. Under direction of processor 323, a non-transitory memory, such as memory cells storing physical states (e.g., memory states), comprising, for example, a program of executable computer instructions, may be executed by processor 323 and able to generate signals to be communicated via a network, for example, as previously described. Generated signals may also be stored in memory, also previously suggested.

Memory 322 may store content, such as relating to one or more users, and may also comprise a computer-readable medium that may carry and/or make accessible content, including code and/or instructions, for example, executable by processor 323 and/or some other device, such as a controller, as one example, capable of executing computer instructions, for example. As previously mentioned, the term content, such as digital content is used throughout this document to refer to a set of associated stored memory states and/or a set of associated physical signals. However, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components may be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, attributes, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining,” “establishing,” “obtaining,” “identifying,” “selecting,” “generating,” and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice- versa in a memory device may comprise a transformation, such as a physical, but non- transitory, transformation. Rather, the foregoing is intended as illustrative examples.

Referring again to FIG. 3, processor 323 may comprise one or more circuits, such as digital circuits, to perform at least a portion of a computing procedure and/or process. By way of example, but not limitation, processor 323 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 323 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 3 also illustrates device 304 as including a component 332 operable with input/output devices, for example, so that signals and/or states may be appropriately communicated between devices, such as device 304 and an input device and/or device 304 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as an optical display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1-23. (canceled)

24. An article comprises: a non-transitory storage medium including stored thereon executable instructions capable of execution by a processor included in a laptop, tablet or smart phone with an optical display consisting essentially of a LCD or an OLED with a front linear polarizing filter;
wherein the instructions are executable to interleave light providing obscuring image content via the optical display and light providing intended image content via the optical display, wherein the light is to be interleaved in a temporal manner based at least in part on polarization state such that viewing the interleaved light through a visual screen is to compensate for the manner in which the light is to be interleaved so as to substantially reveal the intended image content and substantially block the obscuring image content;
wherein the instructions are further executable so that the light is to be interleaved such that the viewing the interleaved light through the visual screen is to filter the interleaved light based at least in part on light polarization state so as to substantially reveal the intended image content and substantially block the obscuring image content.

25. The article of claim 24, wherein the instructions are further executable so that the light providing obscuring image content via the optical display and the light providing intended image content via the optical display is to comprise substantially complementary image content.

26. (canceled)

27. The article of claim 24, wherein the instructions are further executable so that the light is to be interleaved in a temporal manner via the optical display such that the viewing the interleaved light through a visual screen is to comprise viewing the interleaved light through eyewear to filter the interleaved light in a manner so as to substantially reveal the intended image content and substantially block the obscuring image content.

28. The article of claim 27, wherein the instructions are further executable so that the optical display is to produce light providing obscuring image content and light providing intended image content;
wherein the optical display to produce the light providing obscuring image content and to produce the light providing intended image content is to comprise: a liquid crystal display (LCD).

29. The article of claim 28, wherein the instructions are further executable so that the optical LCD is to operate in at least one of the following modes: an electro-optical (EO) mode, a vertically aligned nematic (VAN) mode, an in-plane switching (IPS) mode, a fringe field switching (FFS) mode, a twisted nematic (TN) mode, optically compensated bend (OCB) mode or a polymer dispersed liquid crystal (PDLC) mode.

30. (canceled)

31. (canceled)

32. The article of claim 27, wherein the instructions are further executable so that the light polarization state is to comprise: linear polarization.

33. The article of claim 27, wherein the instructions are further executable so that the light to be interleaved in the temporal manner is to comprise temporally alternating between light providing obscuring image content and light providing intended image content such that viewing the temporally alternating light through eyewear to filter the temporally alternating light is to comprise viewing the temporally alternating light through eyewear to filter the temporally alternating light via light polarization state so as to substantially reveal the intended image content and substantially block the obscuring image content.

34. The article of claim 33, wherein the instructions are further executable so that the light polarization state is to comprise: linear polarization.

35. The article of claim 34, wherein the instructions are further executable such that the viewing the temporally alternating light through eyewear is to comprise viewing the temporally alternating light through active light shutter eyewear that is to synchronize the active light shutter eyewear with the temporally alternating light so as to substantially reveal the intended image content and substantially block the obscuring image content.

36. The article of claim 35, wherein the instructions are further executable such that the viewing the temporally alternating light through the active light shutter eyewear that is to synchronize the active light shutter eyewear with the temporally alternating light is to comprise viewing the temporally alternating light through similarly oriented liquid crystal pi-cells respectively positioned between two polarizing film so as to synchronize the active light shutter eyewear with the temporally alternating light.

37. The article of claim 35, wherein the instructions are further executable so that the temporally alternating between the light providing obscuring image content and the light providing intended image content is to comprise temporally alternating at about 1/120^{th} of a second or faster.

38. The article of claim 35, wherein the instructions are further executable so that the temporally alternating between the light providing obscuring image content and the light providing intended image content is to comprise temporally alternating at a changing time interval.

39. The article of claim 38, wherein the instructions are further executable so that the temporally alternating between the light providing obscuring image content and the light providing intended image content is to comprise temporally alternating at an asynchronously changing time interval.

40. An article comprises: a non-transitory storage medium including stored thereon executable instructions capable of execution by a processor included in a laptop, tablet or smart phone with an optical display comprising a LCD or an OLED such that producing light from immediately successive rows of pixels of the optical display, wherein polarized light providing obscuring image content is to be produced from every other row of the optical display and wherein light providing intended image content substantially orthogonally polarized with respect to the polarized light is to be produced from remaining rows of the optical display;
wherein the instructions are executable so that the light is to be interleaved in a spatial manner via the optical display such that viewing the spatially interleaved light through eyewear to filter the spatially interleaved light is to comprise viewing the spatially interleaved light through eyewear to filter the spatially interleaved light via light polarization state so as to substantially reveal the intended image content and substantially block the obscuring image content. 41. The article of claim 40, wherein the polarization state of the polarized light and the substantially orthogonally polarized light is to comprise at least one of the following: linearly polarized light, circularly polarized light or elliptically polarized light.

42. The article claim of 27,
wherein the instructions are further executable so that the light is to be interleaved in the spatial manner via the optical display such that the viewing the spatially interleaved light through eyewear to filter the spatially interleaved light via light polarization state is to comprise viewing the spatially interleaved light through passive polarization sensitive eyewear to include a substantially quarter wave retarder and to face the optical display with the optical axis oriented at substantially 45 degrees to the transmission axis of a linear polarizer that is to face the viewer's eyes.

43. The article of claim 27,
wherein the instructions are further executable so that the light is to be interleaved in the spatial manner via the optical display such that viewing the spatially interleaved light through eyewear to filter the spatially interleaved light is to comprise viewing the spatially interleaved light through eyewear to filter the spatially interleaved light via light polarization state so as to substantially reveal the intended image content and substantially block the obscuring image content;
wherein the spatially interleaving the light via the optical display is to comprise producing light from immediately successive pixels of the optical display in the vertical and in the horizontal direction, wherein polarized light providing obscuring image content is to be produced from every other pixel of the optical display in the horizontal and in the vertical direction and wherein light providing intended image content substantially orthogonally polarized with respect to the polarized light is to be produced from remaining pixels of the optical display.

44. The article of claim 43, wherein the polarization state of the polarized light and the substantially orthogonally polarized light is to comprise at least one of the following: linearly polarized light, circularly polarized light or elliptically polarized light.

45. The article of claim 27,
wherein the instructions are further executable so that the light is to be interleaved in the spatial manner via the optical display such that viewing the spatially interleaved light through eyewear to filter the spatially interleaved light is to comprise viewing the spatially interleaved light through eyewear to filter the spatially interleaved light via light polarization state so as to substantially reveal the intended image content and substantially block the obscuring image content;
wherein the spatially interleaving the light via the optical display is to comprise producing light from immediately successive columns of pixels of the optical display, wherein polarized light providing obscuring image content is to be produced from every other column of the optical display and wherein light providing intended image content substantially orthogonally polarized with respect to the polarized light is to be produced from remaining columns of the optical display.

46. The article of claim 45, wherein the polarization state of the polarized light and the substantially orthogonally polarized light is to comprise at least one of the following: linearly polarized light, circularly polarized light or elliptically polarized light.
